(19) United States
(12) Patent Application Publication
(10) Pub. No.: US 2015/0356320 A1
(43) Pub. Date: Dec. 10, 2015

(54) ELECTRONIC APPLIANCE COMPRISING A SECURE ELECTRONIC ENTITY AND METHOD IMPLEMENTED IN SUCH AN ELECTRONIC APPLIANCE

(71) Applicant: Oberthur Technologies, Colombes (FR)

(72) Inventors: Olivier CHAMLEY, COLOMBES (FR); Nicolas BOUSQUET, COLOMBES (FR)

(21) Appl. No.: 14/729,682

(22) Filed: Jun. 3, 2015

(30) Foreign Application Priority Data
Jun. 6, 2014 (FR) 1455186

(51) Int. Cl. G06F 21/74; G06F 21/72

(52) U.S. Cl. CPC G06F 21/74; G06F 21/72

(57) ABSTRACT

An electronic appliance includes a first processor and a secure electronic entity equipped with a second processor, the electronic appliance being designed to operate by the execution by the first processor of a trusted operating system. An element situated outside the secure electronic entity and distinct from the trusted operating system is designed to trigger the execution of an application by the second processor; the application executed by the second processor is designed to request the implementation of a service of the trusted operating system. A method implemented in such an electronic appliance is also described.

### TECHNICAL FIELD TO WHICH THE INVENTION PERTAINS

The present invention relates to the securing of electronic appliances.

It relates more particularly to an electronic appliance comprising a first processor and a secure electronic entity equipped with a second processor, the electronic appliance being designed to operate by means of the execution by the first processor of a trusted operating system. The present invention also relates to a method implemented in such an electronic appliance.

The invention applies particularly advantageously in the case where a multi-purpose operating system is also executed within the electronic appliance.

### TECHNOLOGICAL BACKGROUND

Electronic appliances such as defined hereinabove are known, wherein operation is made secure on the one hand by the use of a trusted operating system (or “Trusted OS”), which makes it possible to provide a trusted execution environment (TEE) in which certain applications only can be installed and executed, and on the other hand by the use of a secure electronic entity for the implementation of processing requiring a high security level, such as cryptographic processing of data.

Electronic appliances such as these furthermore generally comprise non-secure elements, for example a multi-purpose operating system (or “Rich OS” as it is referred to) executed within the electronic appliance; within the framework of their operation, these non-secure elements may have to call upon secure functionalities.

In this case provision is conventionally made for the secure functionality requested by the non-secure element to be steered by an application implemented within the framework of the trusted operating system, this application then being in charge of requesting the secure electronic entity in respect of certain processing (typically cryptographic) when necessary.

It is however understood that, in order to perform the service sought by the user, this solution necessitates the installation of applications in the non-secure element, in the trusted execution environment and in the secure electronic entity.

### SUBJECT OF THE INVENTION

In this context, the present invention proposes an electronic appliance such as defined hereinabove, characterized in that an element situated outside the secure electronic entity and distinct from the trusted operating system is designed to trigger the execution of an application by the second processor and in that the application executed by the second processor is designed to request the implementation of a service of the trusted operating system.

Thus, the application, whose execution is triggered by the non-secure element, will be able to steer the implementation of the secure functionality, calling upon services of the trusted operating system when necessary, for example when resources of the electronic appliance that are managed by the trusted operating system must be used in the process steered by the second processor.

Only basic services offered by the trusted operating system will therefore be used and it is therefore no longer necessary to install in the trusted execution environment an application dedicated to the implementation of the service sought by the user.

Furthermore, the secure functionality is steered by the secure electronic entity which offers a security level still higher than that achieved by the trusted execution environment.

According to a first possibility, the distinct element is a multi-purpose operating system implemented within the electronic appliance. A multi-purpose operating system such as this can be designed to be executed by the first processor.

Provision may be made as explained in the description which follows for means for toggling operation between operation based on the multi-purpose operating system and operation based on the trusted operating system.

As a variant, the electronic appliance can comprise a third processor and the multi-purpose operating system can be designed to be executed by this third processor.

According to a second possibility of embodiment, the distinct element is a module of the electronic appliance, equipped for example likewise with a processor, for example a communication module of the electronic appliance.

It is remarked that the distinct element can be designed to directly command the second processor in respect of the triggering of the execution of the application, or be designed to emit a command for triggering the execution of the application destined for the trusted operating system, the trusted operating system then being designed to command the execution of the application by the second processor. In the latter case, the role of the trusted operating system is limited to the transmission of the triggering instruction to the second processor.

The toggling means mentioned above can then be designed to toggle from operation based on the multi-purpose operating system to operation based on the trusted operating system upon the emission of the triggering command.

The service whose implementation is requested by the second processor includes for example the implementation of a functionality of a peripheral (for example a man-machine interface) of the electronic appliance.

This service can include a feedback (such as a display or the emission of a sound signal, or else the activation of a vibrator) of information on a man-machine interface of the electronic appliance and/or the reception of an item of information (for example an authentication item of information) for identifying the user.

The invention also proposes a method implemented in an electronic appliance comprising a first processor and a secure electronic entity equipped with a second processor, the electronic appliance being designed to operate by means of the execution by the first processor of a trusted operating system, comprising the following steps:
triggering, by an element situated outside the secure electronic entity and distinct from the trusted operating system, of the execution of an application by the second processor;
requesting, by the application executed by the second processor, of the implementation of a service of the trusted operating system.

The optional characteristics proposed hereinabove for the electronic appliance can also apply to such a method.

### DETAILED DESCRIPTION OF AN EXEMPLARY EMBODIMENT

The description which follows with regard to the appended drawings, which are given by way of nonlimiting examples, will clearly elucidate the substance of the invention and how it may be carried out.

In the appended drawings:

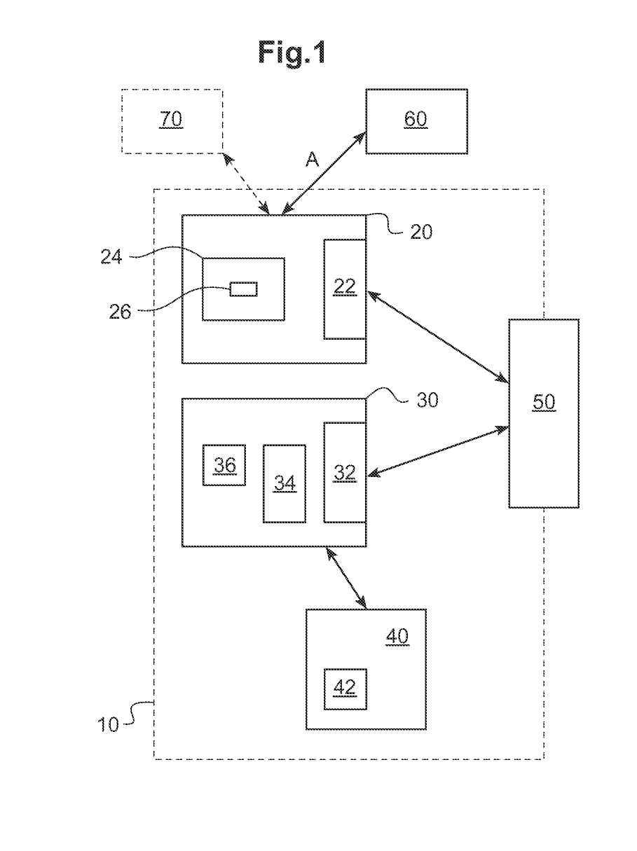

FIG. 1 schematically represents the main elements of a system in which the invention is implemented;

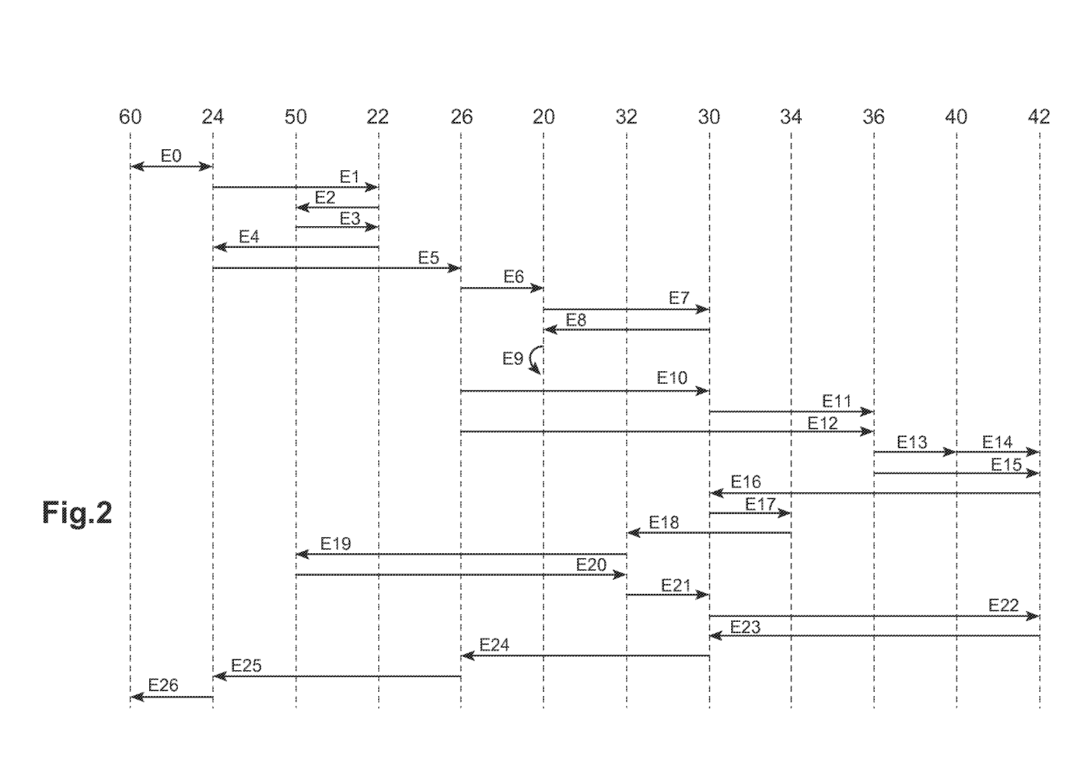

FIG. 2 represents a first example of a method of exchanging data between the elements of the system of FIG. 1, in accordance with the teachings of the invention;

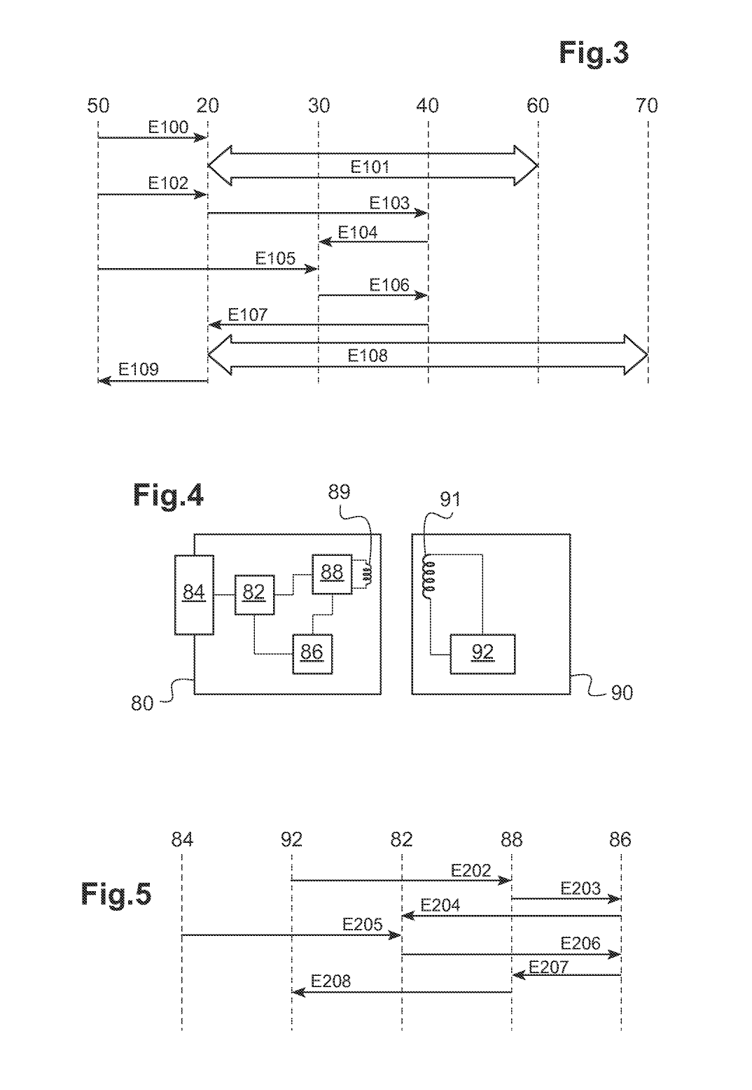

FIG. 3 represents a second example of a method of exchanging data in a system of the type of that of FIG. 1, in accordance with the teachings of the invention; and

FIG. 4 represents another exemplary system in which the invention may be implemented;

FIG. 5 represents an exemplary method of exchanging data between the elements of the system of FIG. 4.

FIG. 1 schematically represents the main elements of a system in which the invention is implemented.

This system comprises an electronic appliance 10, here a terminal (for example of intelligent telephone or “smartphone” type), whose operation is based on the use of two distinct operating systems: a multi-purpose operating system 20 (or “Rich OS” as it is referred to) and a trusted operating system 30 (or “Trusted OS”), sometimes dubbed a secure operating system (“Secure OS”).

The multi-purpose operating system 20 allows the downloading, the installation and the execution of applications with great freedom for the user.

In contradistinction, within the framework of the operation of the electronic appliance 10 on the basis of the trusted operating system 30, the possibilities for downloading and installing applications are limited (for example to applications that have received a particular certification) so that the use of the trusted operating system makes it possible to create a trusted execution environment (TEE) within the electronic appliance 10.

This trusted execution environment offers for example a security level in accordance with the EAL (for “Evaluation Assurance Level”) common criteria, corresponding to ISO standard 15408, with a level of between 2 and 7, or to FIPS (for “Federal Information Processing Standard”) standard 140-2.

In the example described here, the multi-purpose operating system 20 and the trusted operating system 30 are executed by one and the same processor of the electronic appliance, for example a processor of a System on Chip (SoC). In addition to the processor, such a system on chip comprises other electronic elements having diverse functionalities, in particular one or more memories (for example a read-only memory—or ROM for “Read Only Memory”, a random-access memory—or RAM for “Random Access Memory”—and a rewritable non-volatile memory, for example of EEPROM type for “Electrically Erasable and Programmable Read Only Memory”); a part of at least one of these memories can be reserved for the trusted operating system 30 (that is to say this memory part can be read and/or written only by the trusted operating system 30).

In this case provision is made, as mentioned hereinafter, for a process for toggling between operation of the electronic appliance 10 on the basis of the multi-purpose operating system 20 and operation of the electronic appliance 10 on the basis of the trusted operating system 30 so that the electronic appliance 10 operates at each instant on the basis of a single of the two operating systems 20, 30.

As a variant, provision could be made for the multi-purpose operating system 20 and the trusted operating system 30 to be respectively executed on two dedicated processors, for example both onboard a system on chip.

The electronic appliance 10 also comprises a secure electronic entity 40 equipped with a processor; the secure electronic entity 40 is for example a secure integrated circuit (or SE for “Secure Element”), optionally soldered in the electronic appliance 10 (then dubbed eSE for “embedded Secure Element”), or a microcircuit card (or UICC for “Universal Integrated Circuit Card”).

A secure electronic entity such as this is for example in accordance with the EAL (for “Evaluation Assurance Level”) common criteria, corresponding to ISO standard 15408, with a level of between 2 and 7, or to FIPS (for “Federal Information Processing Standard”) standard 140-2.

The emitted commands destined for this electronic entity 40 are for example of APDU type (see for example hereinbelow step E13). As represented schematically in FIG. 1, the electronic entity 40 can likewise emit commands destined for the trusted operating system 30, for example commands of STK type (for “SIM TooKit”).

The electronic appliance 10 finally comprises a user interface (UI) or man-machine interface (MMI) 50, for example a touchscreen, which makes it possible to display information intended for the user and to receive instructions or information from the user, here when the user touches elements (such as virtual buttons) displayed on the touchscreen.

As a variant, the user interface could use other types of input-output device so as to exchange information between the electronic appliance and the user, such as for example a loudspeaker, a microphone or a biometric sensor.

The system presented in FIG. 1 comprises a remote server 60 (belonging for example to a commercial site) which can exchange data with the electronic appliance 10 by communication means represented schematically by the arrow A, which can include in particular a telephone network (here a mobile telephone network) and a data network, for example a computer network such as the Internet network.

The system of FIG. 1 may optionally furthermore comprise a bank server 70, that is to say a server managed by a bank, generally a bank in which the user is the holder of a bank account.

FIG. 2 represents a first exemplary method of exchanging data between the elements of the system of FIG. 1, in accordance with the teachings of the invention.

This method begins in step EU with the exchanging of data between the remote server 60 and a browser 24 (for example an Internet browser or “web browser”) executed by the processor of the electronic appliance 10 within the framework of the environment defined by the multi-purpose operating system 20.

The data received by the browser 24 are then displayed on the touchscreen of the electronic appliance 10. Accordingly, in step E1 the browser 24 calls upon a module for managing the man-machine interface (or MMI) 22. As represented in FIG. 1, such a module for managing the MMI 22 forms part of the services offered by the multi-purpose operating system 20.

The module for managing the MMI 22 then commands in step E2 the display requested on the touchscreen 50.

The user then selects (by touching for example a virtual button on the touchscreen 50) a functionality (for example a payment) which has to be implemented in a secure context.

This selection (in practice the positioning of the user's finger at a given position on the touchscreen 50) is transmitted to the module for managing the MMI 22 in step E3, which relays it to the browser 24 in step E4.

On account of this selection, the browser 24 commands in step E5 the implementation of a module 26 dedicated to this functionality, for example an extension module (or “plug-in” as it is referred to). The browser 24 can then communicate to the dedicated module 26 information associated with the requested functionality, here payment information such as the amount of the transaction, an identifier of the trader, the date of the transaction and a product code.

In step E6, the dedicated module 26 (then executed by the processor of the electronic appliance 10) then requests the active operating system (in this instance the multi-purpose operating system 20) in respect of the toggling to a mode of operation of the electronic appliance 10 based on the other possible operating system (here the trusted operating system 30), that is to say to a mode of operation in a trusted execution environment (or TEE).

The multi-purpose operating system 20 thus commands in step E7 the launching of the trusted operating system 30; the trusted operating system 30 acknowledges receipt in step E8, thereby causing the shutdown of the multi-purpose operating system 20 in step E9. The electronic appliance 10 then operates on the basis of the trusted operating system 30.

The dedicated module 26 can then dispatch to the trusted operating system 30 a command for selecting a trusted application 36 (or TA, sometimes “trustlet”) executable by the processor of the electronic appliance 10 during its operation based on the trusted operating system 30 (step E10).

This selection command is for example accompanied by an identifier of the trusted application 36, such as a unique universal identifier (or UUID for “Universal Unique IDentifier”).

The trusted operating system 30 thus selects in step E11 the trusted application 36 requested (that is to say in practice that the trusted operating system 30 launches the execution of the trusted application 36 by the processor of the electronic appliance 10).

The dedicated module 26 can then dispatch to the trusted application 36 the information associated with the functionality requested by the user (here the payment information) during a step E12.

The trusted application 36 then commands the launching of an applet 42 within the secure electronic entity 40. Accordingly, in step E13, the trusted application 36 dispatches to the secure electronic entity 40 a selection command, accompanied by an identifier of the applet 42 (or AID for “Application IDentifier”). This command is for example a command of APDU type (for “Application Protocol Data Unit”). The secure electronic entity 40 (specifically its operating system executed by the processor of the secure electronic entity 40) then launches the execution, by the processor of the secure electronic entity 40, of the applet thus identified 42 (step E14).

The trusted application 36 can then dispatch the information associated with the functionality requested by the user (here the payment information) to the applet 42 during a step E15.

Before performing the validation of the payment by the secure electronic entity (as described below), the applet 42 implements a process for authenticating the user (by means of the provision by the user of authentication information via the touchscreen 50) as described now.

Accordingly, the applet 42 requests the trusted operating system 30 in respect of the implementation of a service 34 of a library of services which are provided by the trusted operating system 30 (step E16).

This service corresponds for example to the display on the touchscreen 50 of a message requesting the user to input an identification code (for example a PIN code for “Personal Identification Number”) and to standby awaiting entry of the code by the user by means of a virtual keyboard of the touchscreen 50.

As a variant, it could entail the display on the touchscreen 50 of a message requesting the user to identify symbols or images, optionally in a particular order, or to place his finger at a given location on the touchscreen 50 so as to detect a fingerprint of the user.

In these examples, the identification code, the symbols (or images) identified and the fingerprint form respectively the user authentication information.

Generally, user identification data are received by the trusted operating system 30 through an input peripheral (keyboard, touchscreen, biometric sensor, etc.).

The trusted operating system 30 then launches the requested service 34 (step E17). This service 34 calls upon a module for secure management of the MMI 32 (step E18) which commands the display requested on the touchscreen 50 (that is to say in the examples mentioned hereinabove the display of the message requests the entry of an authentication code or the display of the message requesting the placement of the finger) during a step E19. Such a module for secure management of the MMI 32 forms part of the trusted operating system 30, as represented in FIG. 1.

As a variant, provision could be made for the applet 42 executed by the processor of the secure electronic entity 40 to address itself directly to the module for secure management 32 so as to request the display on the touchscreen 50.

The identification or authentication information obtained from the user by means of the user interface 50 (here the touchscreen) is determined at the level of the module for secure management of the MMI 32 (step E20), and then transmitted to the applet 42, optionally by way of the trusted operating system 30 (steps E21 and E22).

The applet 42 can then verify that the identification or authentication information received is indeed that associated with the user (for example by comparing with information stored within the secure electronic entity 40).

If the applet 42 verifies the correspondence between the identification or authentication information received and that stored, the applet 42 prepares an authorization message (for example by signing this message by means of a cryptographic key stored in the secure electronic entity 40) and dispatches this authorization message to the trusted operating system 30 implemented by the electronic appliance 10 in step E23. (If correspondence is not verified, provision may be made for example for the applet 42 to return an error message instead of the authorization message.)

The trusted operating system 30 then transmits the authorization message to the dedicated module 26 (step E24). The authorization message is thus re-employed by the browser 24 (step E25) so as to be transmitted to the remote server 60 during a step E26 to inform the remote server 60 of the actual implementation of the functionality requested by the user, here of the validation of the payment initiated by the user in step E3.

It is remarked that, in the method described hereinabove, all the steps of the user identification or authentication process are implemented through the cooperation of the trusted operating system 30 and of the secure electronic entity 40. Moreover, the identification or authentication process is implemented on the initiative of the applet 42 executed by the processor of the secure electronic entity 40, whose security level is still higher than that ensured by the trusted operating system 30. One thus ensures that the identification or authentication process is not implemented by a malicious program (or “malware”) by means of which an attacker would seek to obtain the user authentication information.

The role of the trusted operating system 30 is thus limited to the exchanging of data with the secure electronic entity 40 and to the provision of services (in particular with a view to access to peripherals of the electronic appliance 10 such as the touchscreen 50) at the request of the secure electronic entity 40, without however steering the progress of the functionality (for example the progress of the transaction), this steering being entrusted to the secure electronic entity 40.

FIG. 3 represents a second exemplary method of exchanging data in a system of the type of that of FIG. 1, in accordance with the teachings of the invention.

This method starts in step E100 with the launching by the user of an on-line purchase application, for example by selecting an icon associated with this purchase application on the touchscreen 50. The on-line purchase application is executed in the environment created by the multi-purpose operating system 20. The on-line purchase application thus calls in particular upon services offered by the multi-purpose operating system 20.

The on-line purchase application then accesses in step E101 remote content stored in the remote server 60 (for example by calling upon a dedicated service of the multi-purpose operating system 20 and through the communication means represented by the arrow A in FIG. 1). This remote content is displayed on the touchscreen 50 (display step not represented in FIG. 3) so as to allow for example the user to select a product that he wishes to purchase, for example by touching an icon displayed alongside an image of the product on the touchscreen 50.

Once the product has been selected by the user (selection step not represented in FIG. 3), the user launches the payment of the product selected by a particular action on the touchscreen 50 (step E102), for example by touching a virtual payment button displayed on the touchscreen 50.

The multi-purpose operating system 20 receives by virtue of this step E102 the item of information regarding the launching of the payment (in practice, the fact that the user has placed his finger on the location of display of the virtual payment button) and then commands in step E103 the launching (that is to say the execution by the processor of the secure electronic entity) of a payment application stored within the secure electronic entity 40.

The payment application executed by the processor of the secure electronic entity 40 sets up a process for authenticating the user.

Accordingly, the payment application executed in the secure electronic entity 40 requests in step E104 the implementation of a service of the trusted operating system 30. This service is aimed at obtaining from the user that the latter provide, by means of the input peripheral of the user interface 50 (here the touchscreen), authentication information, for example as explained hereinabove a password, a personal code (PIN code) or biometric information such as a fingerprint.

The service commands for example the display on the touchscreen 50 of an indication or of a message intended for the user, requesting him to provide the requisite authentication information (display step not represented in FIG. 3).

The user can then provide the requisite authentication information (by an action on the touchscreen 50), which authentication information is thus transmitted to the trusted operating system 30 in step E105.

The trusted operating system 30 then transmits in step E106 this authentication information to the secure electronic entity 40 so that the secure electronic entity 40 can verify this authentication information, for example by comparing with corresponding data stored in the secure electronic entity 40.

If the secure electronic entity 40 detects an inaccuracy in the authentication information obtained from the user, the payment is not finalized and the secure electronic entity 40 returns for example an error message to the multi-purpose operating system 20 (step not represented in FIG. 3).

On the other hand, if the secure electronic entity 40 verifies the accuracy of the authentication information obtained from the user, the secure electronic entity 40 prepares a message for authorizing the transaction (for example a message signed by means of a cryptographic key stored in the secure electronic entity 40) and dispatches in step E107 this authorization message destined for the on-line purchase application executed within the framework of the multi-purpose operating system 20.

It is remarked that the use of the trusted operating system 30 in the course of steps E104 to E106 allows the secure electronic entity 40 to have recourse to the resources of the electronic appliance 10 (here the touchscreen 50), doing so within the framework of the trusted execution environment (or TEE) created by virtue of the trusted operating system 30. The information obtained by means of these resources of the electronic appliance 10 (here the authentication information) will therefore be able to be used by the application executed within the secure electronic entity 40 (here the payment application).

After having received the authorization message (step E107 described hereinabove), the on-line purchase application triggers in step E108 the payment with the bank by exchanging data with the bank server 70, in particular by transmitting the authorization message (for example signed by the secure electronic entity 40 as already indicated) to the bank server 70.

When the transaction has progressed properly by means of the preceding steps, the on-line purchase application commands for example the display of a visual confirmation intended for the user on the touchscreen 50 by calling upon dedicated services of the multi-purpose operating system 20 (step E109).

FIG. 4 represents another exemplary system in which the invention can be implemented.

This other system comprises an electronic appliance 80, here a terminal such as a smartphone, and a reader 90 fitted for example to a turnstile for access to a secure zone. In order to be authorized to pass through the turnstile, a user must present in front of the reader 90 an electronic appliance, for example the electronic appliance 80, containing authorization data.

The electronic appliance 80 comprises a control module 82, a communication module 88 and a man-machine interface 84, for example a touchscreen.

The control module 82 comprises a processor, as well as memories (for example a random-access memory, a read-only memory and a rewritable non-volatile memory), and manages the main functionalities of the electronic appliance. In particular, the control module 82 manages the man-machine interface 84: the control module 82 can dispatch commands for display on the touchscreen 84 and receive information originating from the touchscreen 84, in particular the position of the user's fingers on the touchscreen 84 which may (according to the display set up on the touchscreen 84, for example the display of a virtual button) be interpreted as a particular instruction of the user.

The control module 82 can operate on the basis of a trusted operating system (that is to say the basic functionalities of the operation of the control module are carried out by executing the trusted operating system on the processor of the control module 82), thereby making it possible to create a trusted execution environment or TEE.

In an optional manner, the control module 82 can also operate on the basis of a multi-purpose operating system, as described hereinabove with reference to FIG. 1.

The communication module 88 is connected to an antenna 89 and can thus set up a short-range contactless communication with the reader 90. The communication module 88 is for example of CLF (for “ContactLess Frontend”) type and allows for example the setting up of a communication of NFC (for “Near Field Communication”) type. Such a communication module 88 comprises a processor as well as optionally memories, for example a random-access memory and a rewritable non-volatile memory.

The control module 82 and the communication module 88 are for example linked by a serial link or by a bus.

The electronic appliance 80 also comprises a secure electronic entity 86, for example a secure integrated circuit (or SE for “Secure Element”), here a secure integrated circuit soldered on a printed circuit of the electronic appliance 80 (or eSE for “embedded Secure Element”). As a variant, it could entail a microcircuit card (or UICC for “Universal Integrated Circuit Card”) received in the electronic appliance.

The secure electronic entity 86 is here linked both to the communication module 88 (for example by means of a protocol of SWP for “Single Wire Protocol” or I2C for “Inter Integrated Circuit” type) and also to the control module 82 (likewise, for example by means of a protocol of SWP or I2C type).

The secure electronic entity 86 comprises a processor and memories, for example a random-access memory and a rewritable non-volatile memory. The rewritable non-volatile memory stores the authorization data (which as indicated hereinabove allow the user to pass through the turnstile) or data (for example cryptographic) which allow the secure electronic entity 86 to generate the authorization data expected by the reader 90, as explained below.

The reader 90 comprises a processor 92 connected to an antenna 91.

When the electronic appliance and the reader are sufficiently close (for example when their respective antennas 89, 91 are at a distance of less than 5 cm), the antenna 89 of the electronic appliance 80 is subjected to a magnetic field generated by the reader 90 by means of the antenna 91, thereby allowing an exchange of data between the processor 92 of the reader 90 and the processor of the communication module 88, for example in accordance with ISO/IEC standard 14443.

FIG. 5 represents an exemplary method of exchanging data between the elements of the system of FIG. 4.

It is considered that the user has brought his terminal 80 close to the reader 90 fitted to the turnstile, thereby causing as has just been indicated the setting up of a communication session between the communication module 88 and the processor 92 of the reader 90.

After session initialization steps (not represented), the processor 92 of the reader 90 transmits in step E202 a command to the communication module 88, this command (for example of the type SELECT AID) designating an applet of the secure electronic entity 86.

The communication module 88 transmits in step E203 the command to the secure electronic entity 86 thereby allowing the execution of the designated applet within the secure electronic entity 86. All the subsequent commands will be transmitted to the selected applet.

Before preparing the authorization data, the secure electronic entity 86 will steer a process for authenticating the user of the electronic appliance 80.

Accordingly, on account of the execution of the applet, the secure electronic entity 86 dispatches in step E204 a command intended for the trusted operating system executed by the processor of the control module 82 so that the user can authenticate himself by producing authentication information at the level of the touchscreen 84 or of some other input-output device of the electronic appliance, such as a biometric sensor. The authentication information is for example a password or an identification code (PIN code) entered by the user on a virtual keyboard presented on the touchscreen 84; as a variant, it may entail biometric data obtained by means of the touchscreen 84 or the above-mentioned biometric sensor.

The authentication information presented by the user is transmitted from the touchscreen 84 (or as a variant from some other input-output device) to the trusted operating system executed on the processor of the control module 82 during a step E205.

The authentication information is then transmitted from the trusted operating system to the secure electronic entity 86 (step E206).

The secure electronic entity 86 then verifies that the authentication information does indeed correspond to the user's information (for example stored in the non-volatile memory of the electronic entity) and, in the affirmative, prepares the authorization data. (In the negative, the process is naturally terminated without preparing the authorization data and therefore without authorizing the user's access.)

As already indicated, these authorization data may be data stored in the non-volatile memory of the secure electronic entity 86 or data obtained by the secure electronic entity 86, for example by applying a cryptographic key stored in the non-volatile memory of the secure electronic entity 86 to data received from the reader (appended for example to the command of step E202), for example according to the challenge-response technique.

The secure electronic entity 86 can then communicate the prepared authorization data to the communication module 88 (step E207), the communication module 88 transmitting these authorization data to the processor 92 of the reader 90 (step E208).

On the basis of the authorization data received, the processor 92 of the reader 90 authorizes access to the user by releasing the rotation of the turnstile.

What is claimed, is:

1. An electronic appliance comprising a first processor and a secure electronic entity equipped with a second processor, the electronic appliance being designed to operate by means of the execution by the first processor of a trusted operating system, wherein an element situated outside the secure electronic entity and distinct from the trusted operating system is designed to trigger the execution of an application by the second processor and wherein the application executed by the second processor is designed to request the implementation of a service of the trusted operating system.

2. An electronic appliance according to claim 1, wherein the distinct element is a multi-purpose operating system implemented within the electronic appliance.

3. An electronic appliance according to claim 2, wherein the multi-purpose operating system is designed to be executed by the first processor.

4. An electronic appliance according to claim 3, comprising means for toggling operation between operation based on the multi-purpose operating system and operation based on the trusted operating system.

5. An electronic appliance according to claim 2, wherein the electronic appliance comprises a third processor and in which the multi-purpose operating system is designed to be executed by the third processor.

6. An electronic appliance according to claim 1, wherein the distinct element is a communication module of the electronic appliance.

7. An electronic appliance according to claim 1, wherein the distinct element is designed to directly command the second processor in respect of the triggering of the execution of the application.

8. An electronic appliance according to claim 1, wherein the distinct element is designed to emit a command for triggering the execution of the application destined for the trusted operating system and wherein the trusted operating system is designed to command the execution of the application by the second processor.

9. An electronic appliance according to claim 8, wherein the distinct element is a multi-purpose operating system implemented within the electronic appliance and designed to be executed by the first processor, the electronic appliance comprising means for toggling operation between operation based on the multi-purpose operating system and operation based on the trusted operating system, wherein the toggling means are designed to toggle from operation based on the multi-purpose operating system to operation based on the trusted operating system upon the emission of the triggering command.

10. An electronic appliance according to claim 1, wherein the service includes the implementation of a functionality of a peripheral of the electronic appliance.

11. An electronic appliance according to claim 10, wherein the peripheral is a man-machine interface of the electronic appliance.

12. An electronic appliance according to claim 1, wherein the service includes a feedback of information on a man-machine interface of the electronic appliance.

13. Electronic appliance according to claim 1, wherein the service includes the reception of an item of information for identifying the user.

14. A method implemented in an electronic appliance comprising a first processor and a secure electronic entity equipped with a second processor, the electronic appliance being designed to operate by means of the execution by the first processor of a trusted operating system, comprising the following steps:
triggering, by an element situated outside the secure electronic entity and distinct from the trusted operating system, of the execution of an application by the second processor;
requesting, by the application executed by the second processor, of the implementation of a service of the trusted operating system.
